(19) United States
(12) Patent Application Publication
(10) Pub. No.: US 2025/0379319 A1
(43) Pub. Date: Dec. 11, 2025

(54) BATTERY MODULE AND HOUSING OF SUCH

(71) Applicant: Robert Bosch GmbH, Stuttgart (DE)

(72) Inventors: Bodo Wolf, Bietigheim-Bissingen (DE); Hannes Wemmer, Markgroeningen (DE); Johannes Swoboda, Stuttgart (DE)

(21) Appl. No.: 19/225,333

(22) Filed: Jun. 2, 2025

(30) Foreign Application Priority Data
Jun. 7, 2024 (DE) 10 2024 205 294.9

(51) Int. Cl. H01M 50/284; H01M 10/613; H01M 10/6551; H01M 50/209; H01M 50/224

(52) U.S. Cl. CPC H01M 50/284; H01M 10/613; H01M 10/6551; H01M 50/209; H01M 50/224

(57) ABSTRACT

A battery module has a plurality of battery cells which are accommodated in the interior of a housing of the battery module. Power electronics are further accommodated in the interior of the housing of the battery module. The housing includes a projection which is configured to protrude beyond a remaining part of the housing, and the power electronics are at least partially accommodated within the interior of the projection.

### BACKGROUND

The invention relates to a battery module according to the type defined in the disclosure, as well as a housing of such.

A battery module comprises a plurality of individual battery cells, each of which has a positive voltage tap and a negative voltage tap, wherein the respective voltage taps are electrically conductively connected to one another for an electrically conductive serial and/or parallel connection of the plurality of battery cells to one another and may thus be interconnected to form the battery module. In particular, the battery cells may each have a first voltage tap, in particular, a positive voltage tap, and a second voltage tap, in particular, a negative voltage tap, which are electrically conductively connected to each other by means of cell connectors, such that an electrically serial and/or parallel interconnection is formed. Battery modules, in turn, are further connected together to form batteries or entire battery systems.

### SUMMARY

A battery module with the features of the disclosure provides the advantage that any power electronics of the battery module are reliably temperature-controllable.

According to the invention, a battery module is provided for this purpose. In particular, the battery module is a 12-volt or 48-volt battery module. The battery module comprises a plurality of battery cells which are accommodated in the interior of a housing of the battery module. In particular, the battery cells are configured as lithium-ion battery cells. Furthermore, power electronics are accommodated in the interior of the housing of the battery module. In particular, the power electronics are arranged on a printed circuit board.

According to the invention, the housing has a projection which is designed to protrude beyond a remaining part of the housing. The power electronics are at least partially accommodated in the interior of the projection.

It should be noted at this point that the projection has a comparably large surface area, such that heat may be dissipated over a wide area.

It should be noted at this point that a printed circuit board (PCB) is basically a carrier element for electronic elements, which is used, in particular, for their mechanical attachment and electrical connection to one another. For this purpose, printed circuit boards comprise an electrically insulating material, on which or in which further electrically conductive connections, referred to as conductor tracks, which are preferably formed from copper, are disposed. In particular, the electronic elements are connected to the printed circuit board with a material bond, most preferably soldered, such that an electrically conductive connection is also formed with the conductor tracks.

It is advantageous if the projection is formed on a top side of the battery module. It should be noted at this point that the top side of the battery module is arranged opposite the bottom side of the battery module. Such an arrangement offers the advantage of a simple design, in which the power electronics are arranged above the plurality of battery cells.

It is advantageous if the projection has a longitudinal direction that is parallel to a longitudinal direction of the battery module.

It should be noted at this point that the battery cells are preferably each prismatic in shape and are arranged next to one another with their largest side surfaces adjacent to one another in the longitudinal direction of the battery module. When the battery cells are arranged next to each other in a longitudinal direction of the battery module, the battery cells are accordingly arranged adjacent to each other with their respective largest side surfaces, which are arranged, in particular, at right angles to the upper side surface and the lower side surface. It should be noted at this point that the longitudinal direction of the battery module in this case is accordingly arranged perpendicular to the largest side surfaces of the battery cells.

It should also be noted at this point that the longitudinal direction of the projection is preferably arranged parallel to a longitudinal direction of the power electronics or the printed circuit board.

As a result, a simple arrangement may be provided overall.

It is also particularly advantageous if the projection is arranged at the end of the housing in a longitudinal direction of the battery module. This allows heat to be reliably dissipated from the housing.

Advantageously, the housing is formed from a metallic material, such as aluminum. This offers the advantage that, due to the comparatively good thermal conductivity of the metallic material, reliable heat dissipation may be achieved. In particular, heat is transferred from the power electronics to the printed circuit board and to the housing by means of the thermal compensation material. A metallic material therefore offers the advantage of low thermal resistance and good thermal capacity.

According to a preferred aspect of the invention, the power electronics comprise a first element of the power electronics and a second element of the power electronics. The first element of the power electronics is accommodated in the interior of the projection. In particular, the first element of the power electronics is arranged on a first printed circuit board and the second element of the power electronics is arranged on a second printed circuit board.

For example, the first element could be a power board, which comprises the main current path and exhibits a comparably high power loss. The second element could be a logic board, for example, which exhibits a comparably low power loss. By arranging the first element of the power electronics, preferably entirely, in the interior of the projection, reliable temperature control is possible for elements that require intensive temperature control.

It is expedient if a thermal compensation material is arranged within the projection. In particular, the thermal compensation material is arranged between the housing and the power electronics or between the housing and the printed circuit board on which the power electronics are arranged. This enables reliable thermal conduction to be established between the power electronics and the housing.

It is advantageous if the housing of the battery module further comprises cooling fins, which are connected to the projection and to the remaining part of the housing. This may increase the mechanical stability of the housing, especially the projection, and further improve the temperature control of the battery module.

It should also be noted that the power electronics preferably also rest on the inside of the projection. This provides a reliable mechanical arrangement.

An object of the present invention is also a housing of a battery module as described above.

### BRIEF DESCRIPTION OF THE DRAWINGS

Exemplary embodiments of the invention are illustrated in the drawing and explained in more detail in the following description.

The sole FIGURE,

FIG. 1, shows an embodiment of a battery module according to the invention in a sectional view from the side.

### DETAILED DESCRIPTION

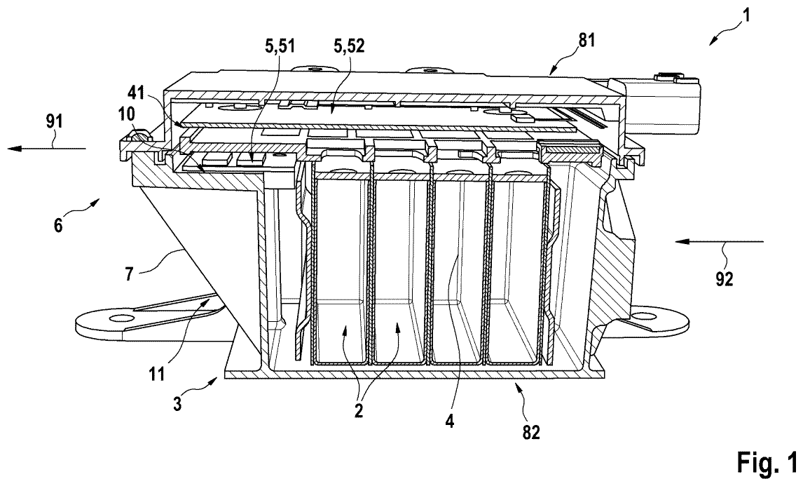

FIG. 1 shows an embodiment of a battery module according to the invention in a sectional view from the side.

The battery module 1 comprises a plurality of battery cells 2, which are accommodated in the interior 4 of a housing 3 of the battery module 1. The housing 3 is formed from a metallic material, such as aluminum, for example.

The housing 3 of the battery module 1 also comprises a projection 6, which protrudes over the remaining part 7 of the housing 3. The projection 6 is formed on a top side 81 of the battery module 1. The top side 81 is formed opposite a bottom side 82 of the battery module 1.

Furthermore, the projection 6 has a longitudinal direction 91, which is arranged parallel to a longitudinal direction 92 of the battery module 1.

It can also be seen that the projection 6 is arranged at an end of the housing 3 in the longitudinal direction 92 of the battery module 1.

Furthermore, power electronics 5 are also accommodated in the interior 4 of the housing 3 of the battery module 1.

As can be seen from FIG. 1, the power electronics 5 are at least partially accommodated in an interior 41 of the projection 6.

In particular, the power electronics 5 comprise a first element 51 of the power electronics 5 and a second element 52 of the power electronics 5. In particular, the first element 51 of the power electronics 5 is accommodated entirely in the interior 41 of the projection 6. In particular, the second element 52 of the power electronics 5 is partially accommodated in the interior 41 of the projection 6.

Furthermore, a thermal compensation material 10 is arranged inside the projection 6.

In addition, the housing 3 of the battery module 1 also comprises cooling fins 11, which are connected to the projection 6 and to the remaining part 7 of the housing 3.

1. A battery module comprising a plurality of battery cells (2), which are accommodated in an interior (4) of a housing (3) of the battery module (1), wherein power electronics (5) are additionally accommodated in the interior (4) of the housing (3) of the battery module (1), wherein the housing (3) comprises a projection (6) which is formed so as to protrude beyond a remaining part (7) of the housing (3), and wherein the power electronics (5) are at least partially accommodated within an interior (41) of the projection (6).

2. The battery module according to claim 1, wherein the projection (6) is formed on a top side (81) of the battery module (1).

3. The battery module according to claim 1, wherein the projection (6) has a longitudinal direction (91), which is arranged parallel to a longitudinal direction (92) of the battery module (1).

4. The battery module according to claim 1, wherein the projection (6) is arranged at an end of the housing (3) in a longitudinal direction (92) of the battery module (1).

5. The battery module according to claim 1, wherein the housing (3) is formed from a metallic material.

6. The battery module according to claim 1, wherein the power electronics (5) comprise a first element (51) of the power electronics (5) and a second element (52) of the power electronics (5), wherein the first element (51) of the power electronics (5) is accommodated in the interior (41) of the projection (6).

7. The battery module according to claim 1, wherein a thermal compensation material (10) is arranged within the projection (6).

8. The battery module according to claim 1, wherein the housing (3) of the battery module (1) comprises cooling fins (11) which are connected to the projection (6) and to the remaining part (7) of the housing (3).

9. A housing of a battery module (1) comprising an interior (4) in which a plurality of battery cells (2) and power electronics (5) may be accommodated, wherein the housing (3) further comprises a projection (6) which is formed to protrude beyond a remaining part (7) of the housing (3), and wherein the power electronics (5) may be accommodated at least partially in an interior (41) of the projection (6).
